(19) United States
(12) Patent Application Publication
(10) Pub. No.: US 2022/0179498 A1
(43) Pub. Date: Jun. 9, 2022

(54) SYSTEM AND METHOD FOR GESTURE-BASED IMAGE EDITING FOR SELF-PORTRAIT ENHANCEMENT

(71) Applicant: Perfect Mobile Corp., New Taipei City (TW)

(72) Inventors: Tung Chia YU, New Taipei City (TW); Chang LI, New Taipei City (TW)

(21) Appl. No.: 17/541,400

(22) Filed: Dec. 3, 2021

Related U.S. Application Data
(60) Provisional application No. 63/122,993, filed on Dec. 9, 2020.

(51) Int. Cl. G06F 3/01; G06V 40/16; G06T 7/246; H04N 5/232; G06T 11/60

(52) U.S. Cl. CPC G06F 3/017; G06V 40/161; G06T 7/246; G06T 2200/24; G06T 11/60; G06T 2207/30201; H04N 5/232935

(57) ABSTRACT

A computing device captures a live video of a user of the computing device and generates a user interface displaying the live video. The computing device detects a facial region of the user and tracks facial features within the facial region of the user. The computing device detects a presence of at least one finger in the live video with a threshold distance of a target facial feature and initiates a corresponding editing mode based on the target facial feature. The computing device edits an appearance of the target facial feature in the live video based on the editing mode and based on movement of the one or more fingers.

### CROSS-REFERENCE TO RELATED APPLICATION

This application claims priority to, and the benefit of, U.S. Provisional Patent Application entitled, “Real time take photo with image editing by gesture,” having Ser. No. 63/122,993, filed on Dec. 9, 2020, which is incorporated by reference in its entirety.

### TECHNICAL FIELD

The present disclosure generally relates to systems and methods for providing gesture-based image editing of a user's facial region.

### BACKGROUND

Many times, individuals wish to perform self-portrait enhancement while viewing a video of themselves using, for example, a front-facing camera on a mobile device. To accomplish this, the individuals must typically perform image editing by navigating a user interface using a touchscreen on the mobile device or by using an input device. In some situations, however, it may be impractical for individuals to access the touchscreen or to use an input device. For example, the mobile device may be attached to a selfie stick where the mobile device is out of reach. Therefore, there is a need for an improved platform for performing image editing.

### SUMMARY

In accordance with one embodiment, a computing device captures a live video of a user of the computing device and generates a user interface displaying the live video. The computing device detects a facial region of the user and tracks facial features within the facial region of the user. The computing device detects a presence of at least one finger in the live video with a threshold distance of a target facial feature and initiates a corresponding editing mode based on the target facial feature. The computing device edits an appearance of the target facial feature in the live video based on the editing mode and based on movement of the one or more fingers.

Another embodiment is a system that comprises a memory storing instructions and a processor coupled to the memory. The processor is configured by the instructions to capture a live video of a user of the computing device and generate a user interface displaying the live video. The processor is further configured to detect a facial region of the user and track facial features within the facial region of the user. The processor is further configured to detect a presence of at least one finger in the live video with a threshold distance of a target facial feature and initiate a corresponding editing mode based on the target facial feature. The processor is further configured to edit an appearance of the target facial feature in the live video based on the editing mode and based on movement of the one or more fingers.

Another embodiment is a non-transitory computer-readable storage medium storing instructions to be implemented by a computing device. The applicator device comprises a processor, wherein the instructions, when executed by the processor, cause the computing device to capture a live video of a user of the computing device and generate a user interface displaying the live video. The processor is further configured to detect a facial region of the user and track facial features within the facial region of the user. The processor is further configured to detect a presence of at least one finger in the live video with a threshold distance of a target facial feature and initiate a corresponding editing mode based on the target facial feature. The processor is further configured to edit an appearance of the target facial feature in the live video based on the editing mode and based on movement of the one or more fingers.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Various aspects of the disclosure can be better understood with reference to the following drawings. The components in the drawings are not necessarily to scale, with emphasis instead being placed upon clearly illustrating the principles of the present disclosure. Moreover, in the drawings, like reference numerals designate corresponding parts throughout the several views.

FIG. 1 is a block diagram of a computing device performing gesture-based image editing for self-portrait enhancement according to various embodiments of the present disclosure.

FIG. 2 is a schematic diagram of the computing device of FIG. 1 in accordance with various embodiments of the present disclosure.

FIG. 3 is a top-level flowchart illustrating examples of functionality implemented as portions of the computing device of FIG. 1 for gesture-based image editing for self-portrait enhancement according to various embodiments of the present disclosure.

FIG. 4 illustrates an example setup where the user holds a computing device in one hand while performing a series of gestures with the other hand to perform image editing according to various embodiments of the present disclosure.

FIG. 5 illustrates an example user interface shown on a display of the computing device of FIG. 1 according to various embodiments of the present disclosure.

FIG. 6A illustrates a first editing mode for performing virtual application of cosmetic effects above the user's eye according to various embodiments of the present disclosure.

FIG. 6B illustrates the user positioning the thumb, index finger, and middle finger in close proximity to the user's face while the user views the virtual mirror displayed in the user interface in FIG. 6A according to various embodiments of the present disclosure.

FIG. 6C illustrates a second editing mode for adjusting a shape of the user's chin according to various embodiments of the present disclosure.

FIG. 7 illustrates a second editing mode for adjusting a shape of the user's chin according to various embodiments of the present disclosure.

FIG. 8 illustrates a third editing mode for adjusting a width of the facial region of the user according to various embodiments of the present disclosure.

FIG. 9 illustrates a fourth editing mode for adjusting modifying a nose shape of the user according to various embodiments of the present disclosure.

### DETAILED DESCRIPTION

The present disclosure relates to systems and methods for gesture-based image editing for self-portrait enhancement. Individuals may wish to perform image editing to enhance certain facial features, where the image editing may comprise for example, virtual application of cosmetic effects or modification of facial feature attributes. To accomplish this, individuals must typically perform image editing by navigating a user interface using a touchscreen or input device. In some situations, however, using a touchscreen or an input device is not feasible. For example, if the user is utilizing a mobile device attached to a selfie stick, using the touchscreen is impractical as the mobile device is typically out of reach to the user. Various embodiments are disclosed for providing users with a touchless image editing technique for self-portrait enhancement by allowing users to utilize gestures to initiate a desired editing mode and to perform editing operations associated with each editing mode.

A description of a system for implementing a gesture-based image editing for self-portrait enhancement is described followed by a discussion of the operation of the components within the system. In particular, embodiments are disclosed for allowing users to edit self-portrait images or videos by utilizing gestures to initiate predefined editing modes without the need for the user to utilize a touchscreen or an input device.

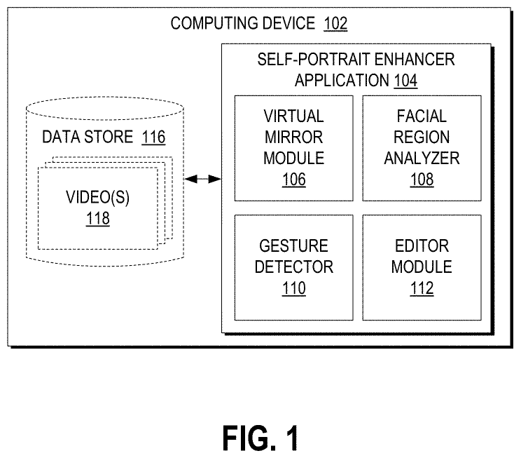

FIG. 1 is a block diagram of a computing device 102 in which the embodiments disclosed herein may be implemented. The computing device 102 may be embodied as a computing device such as, but not limited to, a smartphone, a tablet computing device, a laptop, and so on. A self-portrait enhancer application 104 executes on a processor of the computing device 102 and includes a virtual mirror module 106, a facial region analyzer 108, a gesture detector 110, and an editor module 112.

The virtual mirror module 106 is configured to cause a camera (e.g., front-facing camera) of the computing device 102 to capture a live video of a user of the computing device. A user interface is generated on a display of the computing device 102, and the captured video is displayed for the user of the computing device 102 to view. The live video 118 of the user may be stored in a data store 116. The video 118 stored in the data store 116 may be encoded in formats including, but not limited to, Motion Picture Experts Group (MPEG)-1, MPEG-2, MPEG-4, H.264, Third Generation Partnership Project (3GPP), 3GPP-2, Standard-Definition Video (SD-Video), High-Definition Video (HD-Video), Digital Versatile Disc (DVD) multimedia, Video Compact Disc (VCD) multimedia, High-Definition Digital Versatile Disc (HD-DVD) multimedia, Digital Television Video/High-definition Digital Television (DTV/HDTV) multimedia, Audio Video Interleave (AVI), Digital Video (DV), QuickTime (QT) file, Windows Media Video (WMV), Advanced System Format (ASF), Real Media (RM), Flash Media (FLV), an MPEG Audio Layer III (MP3), an MPEG Audio Layer II (MP2), Waveform Audio Format (WAV), Windows Media Audio (WMA), 360 degree video, 3D scan model, or any number of other digital formats.

The facial region analyzer 108 is configured to detect the facial region of the user and to track the facial features within the facial region of the user. The gesture detector 110 is configured to detect the presence of one or more fingers in the live video 118 on or near a target facial feature and determine a finger type of each of the fingers. In some embodiments, the gesture detector 110 is configured to identify a target facial feature based on the one or more fingers being located within a threshold distance of a target facial feature. A finger type may comprise, for example, the index finger, the middle finger, and so on. In some embodiments, the gesture detector 110 identifies the target facial feature by sensing where the user's one or more fingers remain stationary for a predetermined period of time. For example, the gesture detector 110 identifies the nose as the target facial feature in response to the user holding the thumb, index finger, and/or middle finger stationary on the nose for a predetermined number of seconds. Performing a gesture on a facial feature and then keeping the one or more fingers stationary for a predetermined period of time also determines the corresponding editing mode to be initiated.

The editor module 112 is configured to initiate a corresponding editing mode among a plurality of predefined editing modes based on the target facial feature. In some embodiments, the editing mode may also be determined based on the number of detected fingers and the finger type of each finger. For example, the editor module 112 senses that the user is performing a gesture using the index finger and the thumb and based on this determination, the editor module 112 enters a predefined editing mode for purposes of modifying the appearance of one or more facial features of the user. Note that the target facial feature may be performed using one or more fingers. For some embodiments, the user utilizes a single finger to reshape facial features. For example, the user may utilize a finger to specify (for example, by tapping on a touchscreen) a starting location such as a corner of the eye, a corner of the mouth, a point on the chin, or a point on the nose. From there, the user may perform a swiping gesture with the same finger to adjust the shape of the target facial feature corresponding to the starting location designated by the user.

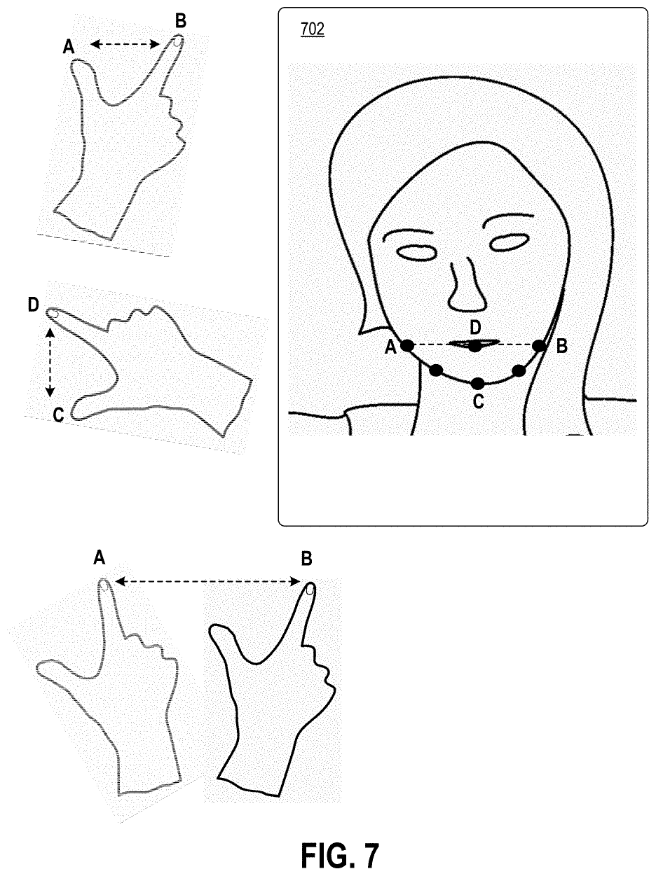

Referring briefly to FIG. 7 as an example, the user may utilize a single finger rather than two fingers to specify or modify the locations of points A, B, C, and/or D by performing a swiping gesture to left or right to reshape facial features. For some embodiments, the user utilizes multiple fingers to reshape facial features. The editing modes are described in more detail below. Referring back to FIG. 1, the ensuing gestures performed by the user cause the editor module 112 is perform specific editing operations on one or more facial features of the user. Where applicable, these gestures can also be used to change the attributes (e.g., color) of a cosmetic effect being applied to one or more facial features. Notably, this touchless technique allows the user to perform editing operations without the need to use a touchscreen of the computing device 102 or input device.

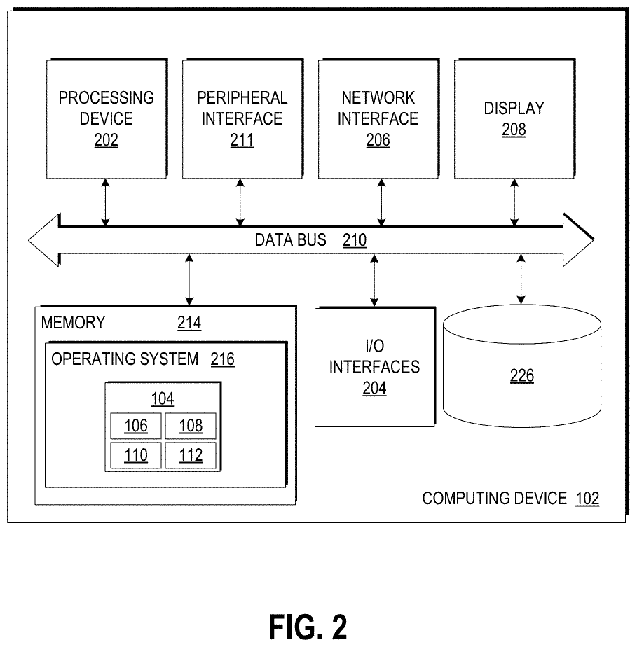

FIG. 2 illustrates a schematic block diagram of the computing device 102 in FIG. 1. The computing device 102 may be embodied as a desktop computer, portable computer, dedicated server computer, multiprocessor computing device, smart phone, tablet, and so forth. As shown in FIG. 2, the computing device 102 comprises memory 214, a processing device 202, a number of input/output interfaces 204, a network interface 206, a display 208, a peripheral interface 211, and mass storage 226, wherein each of these components are connected across a local data bus 210.

The processing device 202 may include a custom made processor, a central processing unit (CPU), or an auxiliary processor among several processors associated with the computing device 102, a semiconductor based microprocessor (in the form of a microchip), a macroprocessor, one or more application specific integrated circuits (ASICs), a plurality of suitably configured digital logic gates, and so forth.

The memory 214 may include one or a combination of volatile memory elements (e.g., random-access memory (RAM, such as DRAM, and SRAM, etc.)) and nonvolatile memory elements (e.g., ROM, hard drive, tape, CDROM, etc.). The memory 214 typically comprises a native operating system 216, one or more native applications, emulation systems, or emulated applications for any of a variety of operating systems and/or emulated hardware platforms, emulated operating systems, etc. For example, the applications may include application specific software which may comprise some or all the components of the computing device 102 displayed in FIG. 1.

In accordance with such embodiments, the components are stored in memory 214 and executed by the processing device 202, thereby causing the processing device 202 to perform the operations/functions disclosed herein. For some embodiments, the components in the computing device 102 may be implemented by hardware and/or software.

Input/output interfaces 204 provide interfaces for the input and output of data. For example, where the computing device 102 comprises a personal computer, these components may interface with one or more user input/output interfaces 204, which may comprise a keyboard or a mouse, as shown in FIG. 2. The display 208 may comprise a computer monitor, a plasma screen for a PC, a liquid crystal display (LCD) on a hand held device, a touchscreen, or other display device.

In the context of this disclosure, a non-transitory computer-readable medium stores programs for use by or in connection with an instruction execution system, apparatus, or device. More specific examples of a computer-readable medium may include by way of example and without limitation: a portable computer diskette, a random access memory (RAM), a read-only memory (ROM), an erasable programmable read-only memory (EPROM, EEPROM, or Flash memory), and a portable compact disc read-only memory (CDROM) (optical).

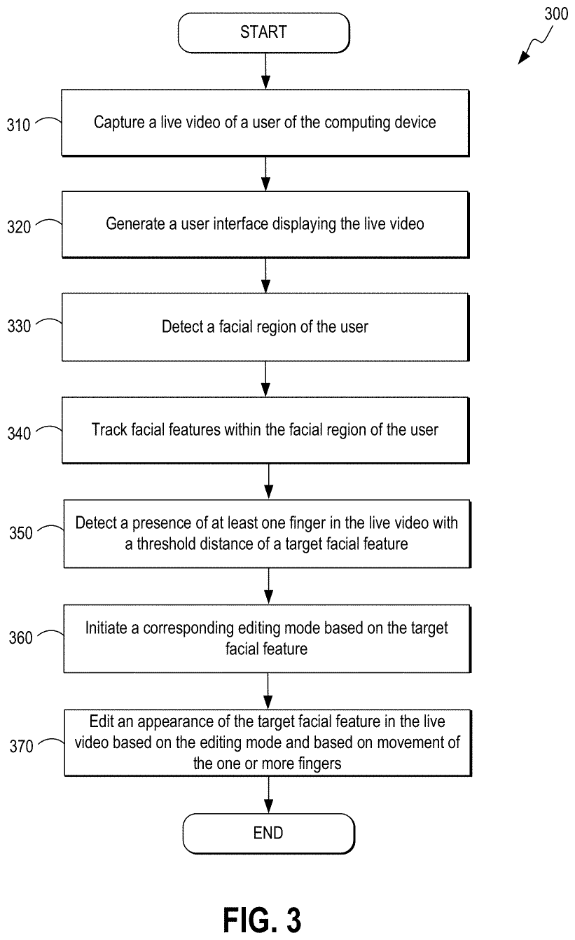

Reference is made to FIG. 3, which is a flowchart 300 in accordance with various embodiments for gesture-based image editing for self-portrait enhancement, where the operations are performed by the computing device 102 of FIG. 1. It is understood that the flowchart 300 of FIG. 3 provides merely an example of the different types of functional arrangements that may be employed to implement the operation of the various components of the computing device 102. As an alternative, the flowchart 300 of FIG. 3 may be viewed as depicting an example of steps of a method implemented in the computing device 102 according to one or more embodiments.

Although the flowchart 300 of FIG. 3 shows a specific order of execution, it is understood that the order of execution may differ from that which is displayed. For example, the order of execution of two or more blocks may be scrambled relative to the order shown. Also, two or more blocks shown in succession in FIG. 3 may be executed concurrently or with partial concurrence. It is understood that all such variations are within the scope of the present disclosure.

At block 310, the computing device 102 captures a live video of a user of the computing device 102 using, for example, a front-facing camera of the computing device 102. At block 320, the computing device 102 generates a user interface on a display of the computing device 102 and displays the live video of the user. At block 330, the computing device 102 detects the facial region of the user depicted in the live video, and at block 340, the computing device 102 begins tracking facial features within the facial region of the user.

At block 350, the computing device 102 detects the presence of at least one finger in the live video with a threshold distance of a target facial feature (e.g., the user's nose), where the user performs gestures to perform self-portrait enhancement of the live video by modifying or applying cosmetic effects to one or more target facial features. For some embodiments, the computing device 102 determines a finger type of each of the fingers detected in the live video. For some embodiments, the computing device 102 specifically monitors for fingers that are extended. At block 360, the computing device 102 initiates a corresponding editing mode based on the target facial feature.

In some embodiments, the plurality of predefined editing modes includes a first editing mode for reshaping an eye of the user. The plurality of predefined editing modes also includes a second editing mode for reshaping a chin of the user. As described in more detail below, the user can use a combination of gestures to modify, for example, the length or shape of the user's chin. The plurality of predefined editing modes also includes a third editing mode for modifying a width of the facial region. Similarly, the user can use a combination of gestures to modify, for example, the width of the user's face. The plurality of predefined editing modes also includes a fourth editing mode for reshaping a nose of the user and a fifth editing mode for reshaping a mouth of the user.

At block 370, the computing device 102 edits the appearance of the target facial feature in the live video based on the editing mode and based on movement of the one or more fingers. In some embodiments, the computing device 102 edits the live video based on the first editing mode and based on the movement of one finger or based on the movement of an index finger and a thumb of the user.

In some embodiments, the computing device 102 edits the live video based on the second editing mode and based on the movement of the one or more fingers by reshaping the chin of the user based on the movement of one finger or based on the movement of an index finger and a thumb of the user. In such embodiments, the computing device 102 calculates an arc extending to a chin of the user from a horizontal line defined by the index finger and the thumb, wherein a line extending from the horizontal line to the arc represents a length of the chin of the user. The computing device 102 then reshapes the chin of the user based on the arc.

In some embodiments, the computing device 102 edits the live video based on the third editing mode and based on the movement of the one or more fingers by reshaping a width of the facial region based on the movement of one finger or based on movement of an index finger and a thumb of the user. In such embodiments, the computing device 102 reshapes a width of the facial region based on the width of a line defined by the one or more fingers. In some embodiments, the computing device 102 edits the live video based on the fourth editing mode and based on the movement of the one or more fingers by reshaping the nose of the facial region based on the movement of one finger or based on the movement of an index finger and a thumb of the user. For some embodiments, the target nose region is defined based on placement of an index finger and a thumb of the user with respect to one another around a nose of the user displayed in the live video. In such embodiments, the computing device 102 reshapes the nose based on the target nose region. Thereafter, the process in FIG. 3 ends.

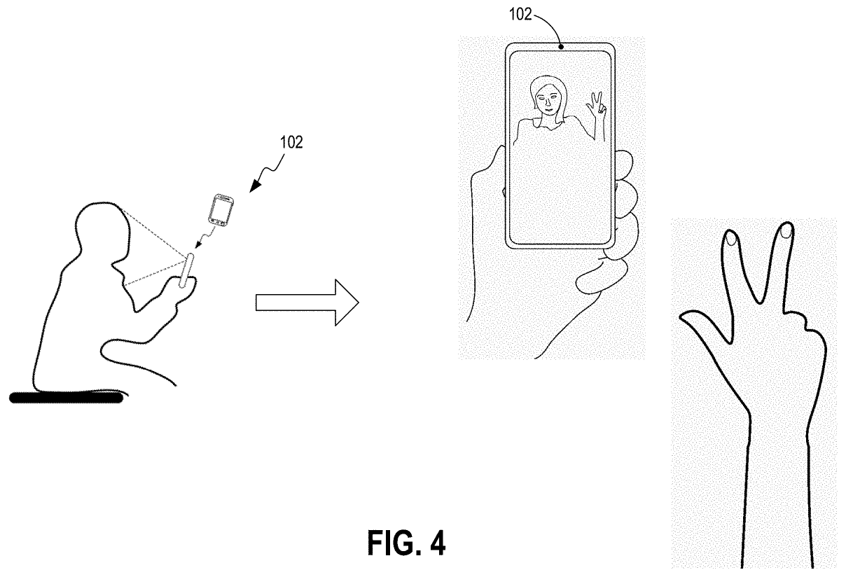

Reference is made to FIGS. 4-9, which further illustrate various aspects of the present invention. Note that although the illustrations shown in these figures show the use of three fingers in some instances, the user may alternatively use two fingers (e.g., the thumb and index finger) or even a single finger to execute the same operations. FIG. 4 illustrates an example setup where the user holds a computing device 102 embodied as a smartphone or other portable computing device in one hand while performing a series of gestures with the other hand to perform image editing. The number of detected fingers and the ensuing gestures performed by the detected fingers allow the user to perform self-portrait enhancement operations without the need to use a touchscreen or other input device to control the computing device 102. Note that FIG. 4 merely illustrates one example setup. In an alternative setup, computing device 102 may be embodied as a laptop computing equipped with a webcam where the user sits in front of the laptop and performs gestures to perform the self-portrait enhancement techniques disclosed herein.

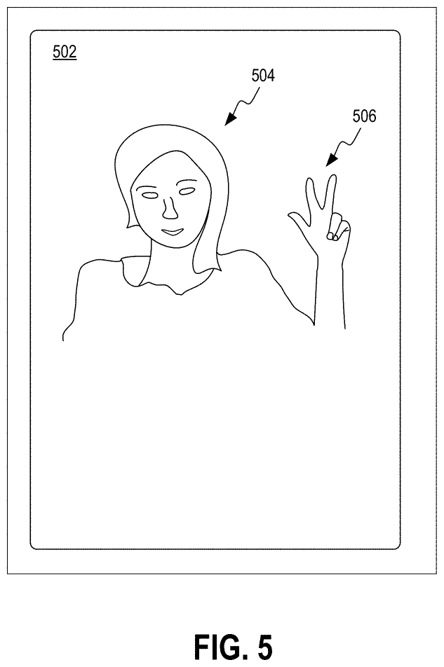

FIG. 5 illustrates an example user interface 502 shown on a display of the computing device 102 of FIG. 1. In the example shown, a front-facing camera of the computing device 102 records a live video of the user of the computing device 102 and displays the live video in the user interface 502, thereby providing the user with a virtual mirror effect for performing image editing. While viewing the virtual mirror, the user performs gestures in close proximity to the user's face to initiate a desired editing mode and to perform corresponding editing operations.

As described above, the facial region analyzer 108 (FIG. 1) executing in the computing device 102 detects a facial region 504 of the user and begins tracking facial features within the facial region 504 of the user. FIG. 5 shows the user raising a hand, thereby causing the gesture detector 110 (FIG. 1) to detect the presence of multiple fingers in the live video. In some embodiments, the gesture detector 110 is configured to detect fingers that are in an extended position. In the example shown, the gesture detector 110 detects the presence of two fingers in the live video. The number of fingers detected by the gesture detector 110 and the ensuing gesture performed by those fingers determine which editing mode is initiated by the editor module 112 (FIG. 1).

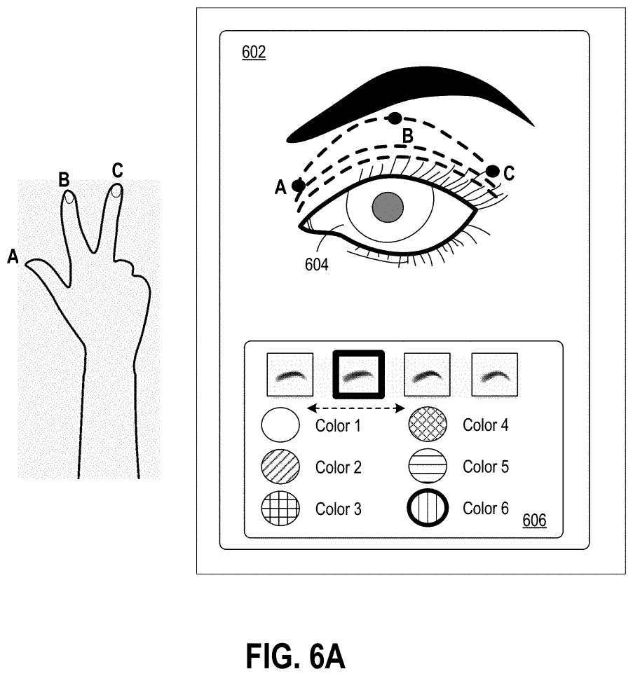

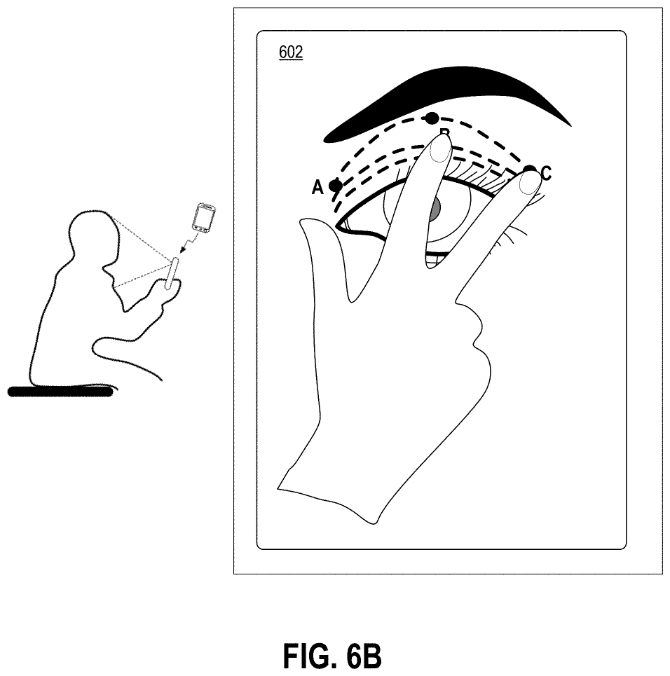

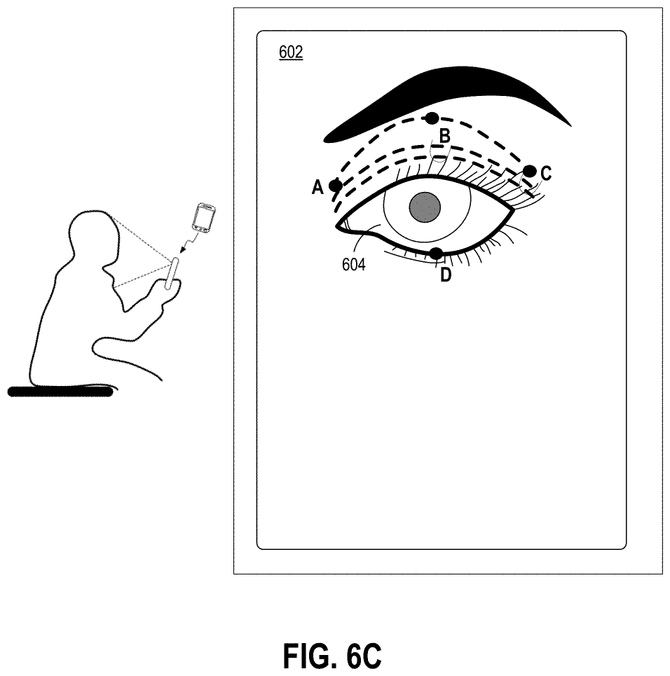

FIG. 6A illustrates a first editing mode for performing virtual application of cosmetic effects above the user's eye 604. In a first editing mode, the user utilizes the touchless techniques described herein to perform eye makeup control where a multi-layered eyeshadow effect is applied to the eye 604 of the user of the computing device (FIG. 1). In some embodiments, the user utilizes the thumb, index finger, and middle finger to form a target area for defining a size of an eyeshadow brush. With reference to FIG. 6B, the user positions the thumb, index finger, and middle finger in close proximity to the user's face while the user views the virtual mirror displayed in the user interface 602.

In the example shown, the fingers correspond to points A, B, and C above the user's eye 604. By adjusting the positioning of each point (e.g., positioning of the index finger for point B), the user defines a target area in which the eyeshadow effect is applied. In particular, the size of the eyeshadow brush is adjusted based on the location of points A, B, and C, and the eyeshadow effect is then only applied to the target area. In the example shown, the user interface 602 also includes an attributes toolbox 606 that allows the user to specify attributes of the eyeshadow effect (e.g., color). In some embodiments, the user navigates the attributes toolbox 606 by performing a combination of horizontal and vertical swipe gestures using, for example, the index finger.

FIG. 6C illustrates a second editing mode for adjusting a shape of the user's eye. In some embodiments, the user utilizes two-finger gestures to adjust a shape of the user's eye. In the example user interface 602 shown, the width of the line extending from point A to point C defines the width of the user's eye, where the user specifies the width using the thumb and index finger or the thumb and middle finger. In the example user interface 602 shown, the width of the line extending from point B to point D defines the width of the user's eye, where the user specifies the width using the thumb and index finger or the thumb and middle finger.

As discussed earlier, for some embodiments, the user may utilize a single finger rather than two fingers to specify or modify the locations of points A or C (e.g., a corner of the eye), as shown in FIG. 6C. Similarly, the user may utilize a single finger rather than two fingers to specify or modify the locations of points B or D, as shown in FIG. 6C. In some embodiments, the user may utilize a single finger rather than two fingers to specify or modify the locations of points A, B, C, or D by performing a swiping gesture to the left or to right to reshape the width of the user's eye.

FIG. 7 illustrates a second editing mode for adjusting a shape of the user's chin. In some embodiments, the user utilizes two-finger gestures to adjust a shape of the user's chin. In the example user interface 702 shown, the width of the line extending from point A to point B defines the width of the user's chin, where the user specifies the width using the thumb and index finger or the thumb and middle finger. As discussed earlier, for some embodiments, the user may utilize a single finger rather than two fingers to specify or modify the locations of points A, B, C, and/or D, as shown in FIG. 7. Once the user specifies the width of the line, the editor module 112 (FIG. 1) automatically calculates an arc through points A, B and C, where the contour of the bottom region of the user's facial region is aligned with the calculated arc, thereby modifying the shape of the user's chin. In FIG. 7, the length of the line extending from point C to point D represents the length of the user's chin, where the user again utilizes the thumb and index finger to adjust the length of this line to further adjust the shape of the user's chin.

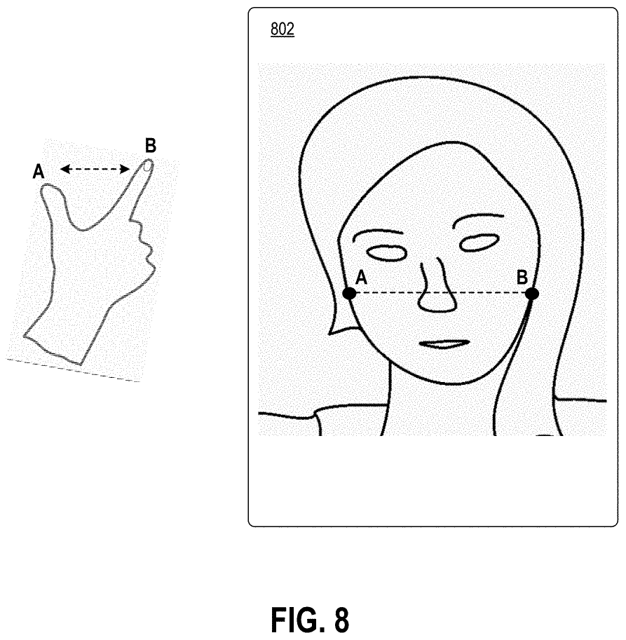

FIG. 8 illustrates a third editing mode for adjusting a width of the facial region of the user. In some embodiments, the user utilizes two-finger gestures to adjust the width of the user's face by specifying the spacing between the user's cheeks while viewing the user interface 802. As discussed earlier, for some embodiments, the user may utilize a single finger rather than two fingers to specify or modify the locations of points A or B, as shown in FIG. 8. In the example user interface 802 shown, the width of the line extending from point A to point B across the user's nose in the middle region of the face defines the width of the user's face, where the user specifies the width using the thumb and index finger or the thumb and middle finger. In some embodiments, the user may utilize a single finger rather than two fingers to specify or modify the locations of points A or B by performing a swiping gesture to the left or to the right to reshape the width of the user's face.

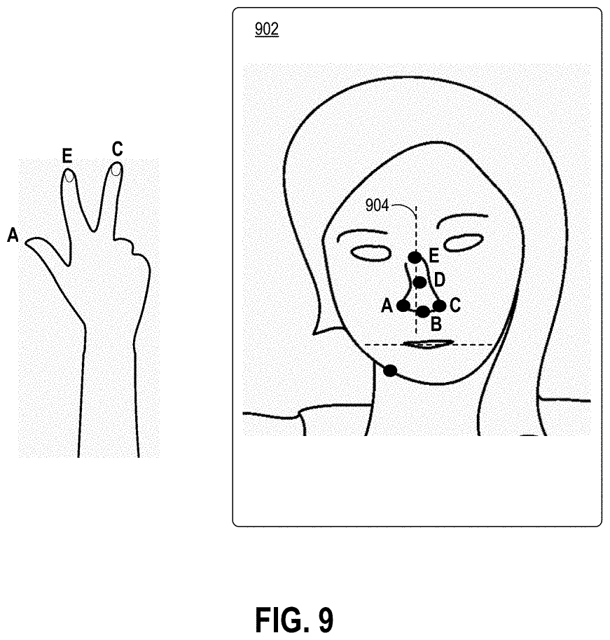

FIG. 9 illustrates a fourth editing mode for adjusting modifying a nose shape of the user. In some embodiments, the user utilizes the thumb, index finger, and middle finger to form a target area for defining a size of the user's nose. In the example shown, the width of the line extends from point A to point C, where the user specifies the width using the thumb and index finger or the thumb and middle finger. In the example shown, the width of the line extends from point B to point E, where the user specifies the width using the thumb and index finger or the thumb and middle finger. In the example shown, the fingers correspond to points A, E, and C on the user's nose, where a vertical axis 904 is formed through point E. By adjusting the positioning of each point (e.g., positioning of the index finger for point E), the user modifies the width of the nose and the length of the nose bridge while viewing the user interface 902. The user may also adjust the shape of the nose by adjusting the positioning of points A, D, and C. In particular, the user adjusts the size of the nose by only adjusting the positioning of point D while points A and C remain stationary. The user may also adjust a length of the nose by using the thumb and index finger to adjust the distance between points B and E. Again, although the illustrations described above involve the use of three fingers in some instances, the user may alternatively use two fingers (e.g., the thumb and index finger) or even a single finger to execute the same operations. As discussed earlier, for some embodiments, the user may utilize a single finger rather than two fingers to specify or modify the locations of points A, B, C, D, or E, as shown in FIG. 9. In some embodiments, the user may utilize a single finger rather than two fingers to specify or modify the locations of points A, B, C, D, or E by performing a swiping gesture to left or right, up or down to reshape the width of the user's face.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A method implemented in a computing device, comprising:
capturing a live video of a user of the computing device;
generating a user interface displaying the live video;
detecting a facial region of the user;
tracking facial features within the facial region of the user;
detecting a presence of at least one finger in the live video within a threshold distance of a target facial feature;
initiating a corresponding editing mode based on the target facial feature; and
editing an appearance of the target facial feature in the live video based on the editing mode and based on movement of the one or more fingers.

2. The method of claim 1, wherein the corresponding editing mode is selected from one of a plurality of predefined editing modes, wherein the editing mode comprises one of:
a first editing mode for reshaping an eye of the user;
a second editing mode for reshaping a chin of the user;
a third editing mode for modifying a width of the facial region;
a fourth editing mode for reshaping a nose of the user; and
a fifth editing mode for reshaping a mouth of the user.

3. The method of claim 2, wherein editing the live video based on the first editing mode and based on the movement of the one or more fingers comprises reshaping the eye of the user based on the movement of one finger or based on the movement of an index finger and a thumb of the user.

4. The method of claim 2, wherein editing the live video based on the second editing mode and based on the movement of the one or more fingers comprises reshaping the chin of the user based on the movement of one finger or based on the movement of an index finger and a thumb of the user.

5. The method of claim 2, wherein editing the live video based on the third editing mode and based on the movement of the one or more fingers comprises reshaping a width of the facial region based on the movement of one finger or based on movement of an index finger and a thumb of the user.

6. The method of claim 2, wherein editing the live video based on the fourth editing mode and based on the movement of the one or more fingers comprises reshaping the nose of the facial region based on the movement of one finger or based on the movement of an index finger and a thumb of the user.

7. A system, comprising:
a memory storing instructions;
a processor coupled to the memory and configured by the instructions to at least:
capture a live video of a user;
generate a user interface displaying the live video;
detect a facial region of the user;
track facial features within the facial region of the user;
detect a presence of at least one finger in the live video within a threshold distance of a target facial feature;
initiate a corresponding editing mode based on the target facial feature; and
edit an appearance of the target facial feature in the live video based on the editing mode and based on movement of the one or more fingers.

8. The system of claim 7, wherein the corresponding editing mode is selected from one of a plurality of predefined editing modes, wherein the editing mode comprises one of:
a first editing mode for reshaping an eye of the user;
a second editing mode for reshaping a chin of the user;
a third editing mode for modifying a width of the facial region;
a fourth editing mode for reshaping a nose of the user; and
a fifth editing mode for reshaping a mouth of the user.

9. The system of claim 8, wherein the processor is configured to edit the live video based on the first editing mode and based on the movement of the one or more fingers by reshaping the eye of the user based on the movement of one finger or based on the movement of an index finger and a thumb of the user.

10. The system of claim 8, wherein the processor is configured to edit the live video based on the second editing mode and based on the movement of the one or more fingers by reshaping the chin of the user based on the movement of one finger or based on the movement of an index finger and a thumb of the user.

11. The system of claim 8, wherein the processor is configured to edit the live video based on the third editing mode and based on the movement of the one or more fingers by reshaping a width of the facial region based on the movement of one finger or based on movement of an index finger and a thumb of the user.

12. The system of claim 8, wherein the processor is configured to edit the live video based on the fourth editing mode and based on the movement of the one or more fingers by reshaping the nose of the facial region based on the movement of one finger or based on the movement of an index finger and a thumb of the user.

13. A non-transitory computer-readable storage medium storing instructions to be implemented by a computing device having a processor, wherein the instructions, when executed by the processor, cause the computing device to at least:
capture a live video of a user of the computing device;
generate a user interface displaying the live video;
detect a facial region of the user;
track facial features within the facial region of the user;
detect a presence of at least one finger in the live video within a threshold distance of a target facial feature;
initiate a corresponding editing mode based on the target facial feature; and
edit an appearance of the target facial feature in the live video based on the editing mode and based on movement of the one or more fingers.

14. The non-transitory computer-readable storage medium of claim 13, wherein the corresponding editing mode is selected from one of a plurality of predefined editing modes, wherein the editing mode comprises one of:
a first editing mode for reshaping an eye of the user;
a second editing mode for reshaping a chin of the user;
a third editing mode for modifying a width of the facial region;
a fourth editing mode for reshaping a nose of the user; and
a fifth editing mode for reshaping a mouth of the user.

15. The non-transitory computer-readable storage medium of claim 14, wherein the processor is configured to edit the live video based on the first editing mode and based on the movement of the one or more fingers by reshaping the eye of the user based on the movement of one finger or based on the movement of an index finger and a thumb of the user.

16. The non-transitory computer-readable storage medium of claim 14, wherein the processor is configured to edit the live video based on the second editing mode and based on the movement of the one or more fingers by reshaping the chin of the user based on the movement of one finger or based on the movement of an index finger and a thumb of the user.

17. The non-transitory computer-readable storage medium of claim 14, wherein the processor is configured to edit the live video based on the third editing mode and based on the movement of the one or more fingers by reshaping a width of the facial region based on the movement of one finger or based on movement of an index finger and a thumb of the user.

18. The non-transitory computer-readable storage medium of claim 14, wherein the processor is configured to edit the live video based on the fourth editing mode and based on the movement of the one or more fingers by reshaping the nose of the facial region based on the movement of one finger or based on the movement of an index finger and a thumb of the user.
